(19) United States
(12) Patent Application Publication
(10) Pub. No.: US 2026/0024989 A1
(43) Pub. Date: Jan. 22, 2026

(54) MULTIPLE CHARGING PATH CONTROL DEVICE FOR USE IN ELECTRONIC DEVICE WITH MULTIPLE CHARGING CONNECTION INTERFACES

(71) Applicant: Realtek Semiconductor Corp., HsinChu (TW)

(72) Inventors: DANDAN ZHU, Suzhou City (CN); Jiwei Dei, Suzhou City (CN); Congyu Zhang, Suzhou City (CN); Min Xu, Suzhou City (CN); Yuanjie Miao, Suzhou City (CN)

(73) Assignee: Realtek Semiconductor Corp., HsinChu (TW)

(21) Appl. No.: 18/986,732

(22) Filed: Dec. 19, 2024

(30) Foreign Application Priority Data
Jul. 17, 2024 (CN) 202410957624.6

(51) Int. Cl. H02J 1/08; H02J 7/00

(52) U.S. Cl. CPC H02J 1/084; H02J 7/007188

(57) ABSTRACT

A multiple charging path control device includes: first and second charging paths, respectively utilized for selectively providing first and second charging currents from first and second power sources to an electronic device based on first and second path switching signals; first and second path control circuits, respectively utilized for generating the first and second path switching signals based on at least first and second path main control signals; and a control signal generation unit utilized for generating the first and second path main control signals and adjusting the first and second path main control signals according to connection status of power sources and the electronic device. When the first power source is coupled to the electronic device, the control signal generation unit asserts the first path main control signal to enable the first charging path and disable the second charging path.

### BACKGROUND OF THE INVENTION

### 1. Field of the Invention

The present invention relates to power supply/charging management for electronic devices, and more specifically to a multiple power supply/charging path control device for electronic devices equipped with multiple connection interfaces.

### 2. Description of the Prior Art

Universal Serial Bus (USB) Type-C interface has been widely adopted in numerous electronic devices, such as smartphones, tablets, laptops, digital cameras, and other portable electronic devices, due to its excellent versatility and convenience. Particularly in the laptop sector, with technological advancements, an increasing number of laptops are equipped with multiple USB Type-C interfaces, supporting not only data transfer and video output but also power delivery. However, when multiple USB Type-C interfaces are simultaneously connected to power supply devices, voltage backflow may occur. Consequently, effectively managing multiple power supply paths and preventing device damage caused by voltage backflow has become an urgent issue to address. Currently, USB Type-C and Power Delivery (PD) standards does not have clear specifications for charging management of multiple USB Type-C interfaces, leading to the emergence of various charging management mechanisms in the market. One of designs sets a PD controller of a specific USB Type-C interface as a master controller, with the others set as slave controllers. The master and slave controllers exchange status information, with the master controller responsible for managing the charging paths. In another one of designs, an embedded controller of the laptop is used to obtain status information from PD controllers of each USB Type-C interface to manage the charging paths. However, these designs involve information exchange between controllers, which may result in response delays. In some scenarios, the transfer of control authority is required, making the charging path management process complex and prone to errors. Therefore, there is a need in the field for a mechanism to manage charging paths for multiple Type-C interfaces.

### SUMMARY OF THE INVENTION

In light of above, it is one object of the present invention to provide a multiple power supply/charging path control device. In the embodiments of the present invention, the core of path control in the multiple power supply/charging path control device is implemented based on hardware-only circuitry, eliminating the need for message exchange between various controllers. The control logic is simple and does not involve the transfer of control authority, thereby enhancing control speed, efficiency, and flexibility while ensuring device safety.

According to one embodiment, a multiple charging path control device is provided. The multiple charging path control device can be used in an electronic device with multiple connection interfaces. The multiple charging path control device comprises: a first charging path, a second charging path, a first path control circuit, a second path control circuit and a control signal generation unit. The first charging path is configured to selectively provide a first charging current from a first power source to the electronic device according to a first path switching signal. The second charging path is configured to selectively provide a second charging current from a second power source to the electronic device according to a second path switching signal. The first path control circuit is coupled to the first charging path, and configured to generate the first path switching signal based on at least a first path main control signal. The second path control circuit is coupled to the second charging path, and configured to generate the second path switching signal based on at least the first path main control signal and a second path main control signal. The control signal generation unit is coupled to the first path control circuit and the second path control circuit, configured to generate the first and second path main control signals and adjusting the first and second path main control signals according to connection status of the first and second power sources and the electronic device. When the first power source is coupled to the electronic device, the control signal generation unit is configured to assert the first path main control signal, causing the first path control circuit to generate the first path switching signal that can enable the first charging path, and simultaneously causing the second path control circuit to generate the second path switching signal that cannot enable the second charging path.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a multiple charging path control device and an electronic device with multiple connection interfaces according to one embodiment of the present invention.

FIG. 2A illustrates a detailed schematic diagram of a multiple charging path control device according to a first embodiment of the present invention.

FIG. 2B illustrates a detailed schematic diagram of a control signal generation unit according to the first embodiment of the present invention.

FIG. 2C illustrates a detailed schematic diagram of a first path control circuit according to the first embodiment of the present invention.

FIG. 2D illustrates a detailed schematic diagram of a second path control circuit according to the first embodiment of the present invention.

FIG. 3A illustrates a detailed schematic diagram of a multiple charging path control device according to a second embodiment of the present invention.

FIG. 3B illustrates a detailed schematic diagram of a control signal generation unit according to the second embodiment of the present invention.

FIG. 3C illustrates a detailed schematic diagram of a first path control circuit according to the second embodiment of the present invention.

FIG. 3D illustrates a detailed schematic diagram of a second path control circuit according to the second embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

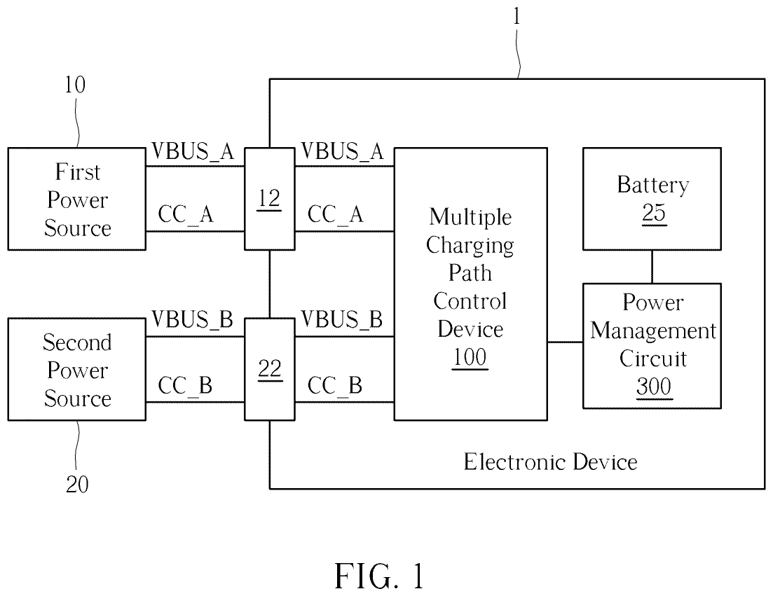

FIG. 1 illustrates an electronic device and a multiple charging (power supply) path control device according to an embodiment of the present invention. As shown in the figure, an electronic device 1 includes connection interfaces 12 and 22, a multiple charging path control device 100, a battery 25, and a power management circuit 300. In one embodiment, the electronic device 1 can be (but is not limited to): a smartphone, tablet, laptop, digital camera, or other portable electronic device. The connection interfaces 12 and 22 can be connected to a first power source 10 and a second power source 20 respectively, providing power to the electronic device 1. In one embodiment, the connection interfaces 12 and 22 can be universal serial bus (USB) Type-C interfaces, supplying power or charging the electronic device 1 based on various types of USB power protocols/standards (such as USB Battery Charging (BC), USB Power Delivery (PD)). In one embodiment, the first power source 10 and the second power source 20 can be AC-to-DC power supply adapters, power banks, or any power supply equipment capable of powering the electronic device 1.

The first power source 10 and the second power source 20 provide charging/power supply currents Ia and Ib to the electronic device 1 through signal lines VBUS_A and VBUS_B, respectively. Additionally, the first power source 10 and the second power source 20 exchange information with the electronic device 1 through signal lines CC_A and CC_B, respectively, based on specific power supply protocols/standards, to configure the power supply/charging status, such as setting the roles of power source and power sink, and configuring power supply/charging voltage and current. The multiple charging path control device 100 is configured to manage charging (power supply) paths from the first power source 10 or the second power source 20 to the electronic device 1, providing charging/power supply current Ia or Ib to the power management circuit 300, thereby charging the battery 25, or directly powering the electronic device 1 when the battery 25 is not installed.

Please note that the term “charging” used in the following descriptions also encompasses the meaning of “power supply.” In specific situations, the electronic device 1 under discussion may not include a battery 25, so the term “charging” mentioned here actually covers the scenario of directly supplying power to the electronic device 1. For the sake of concise description, the term “charging” will be used consistently, but please understand that it also refers to the power supply process. However, this choice of terminology is intended to simplify the expression and does not limit the substantive scope of the present invention.

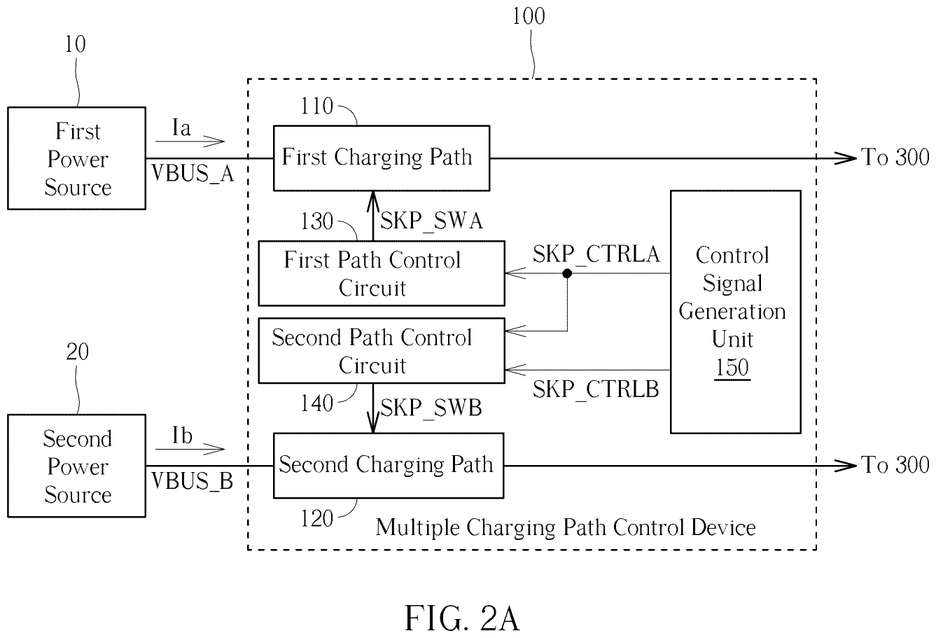

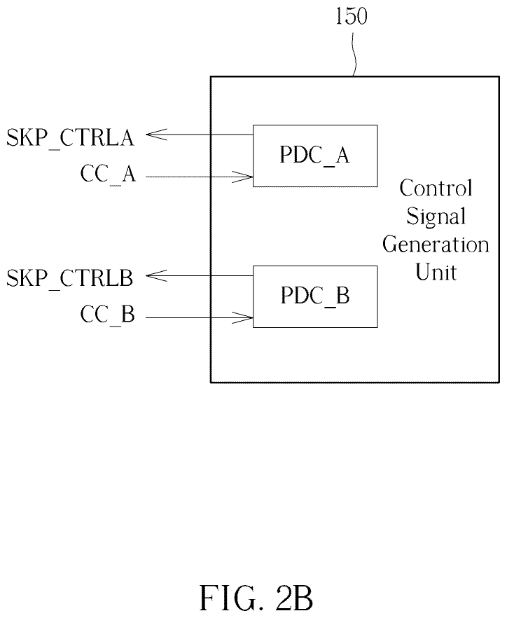

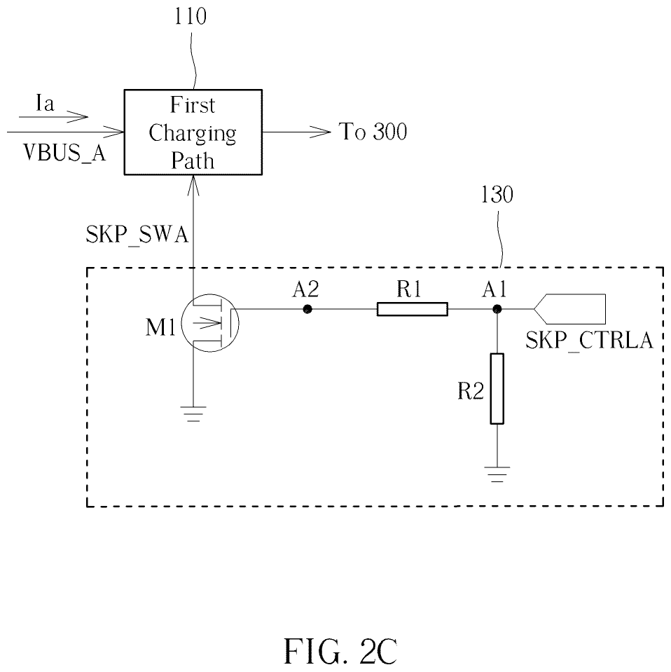

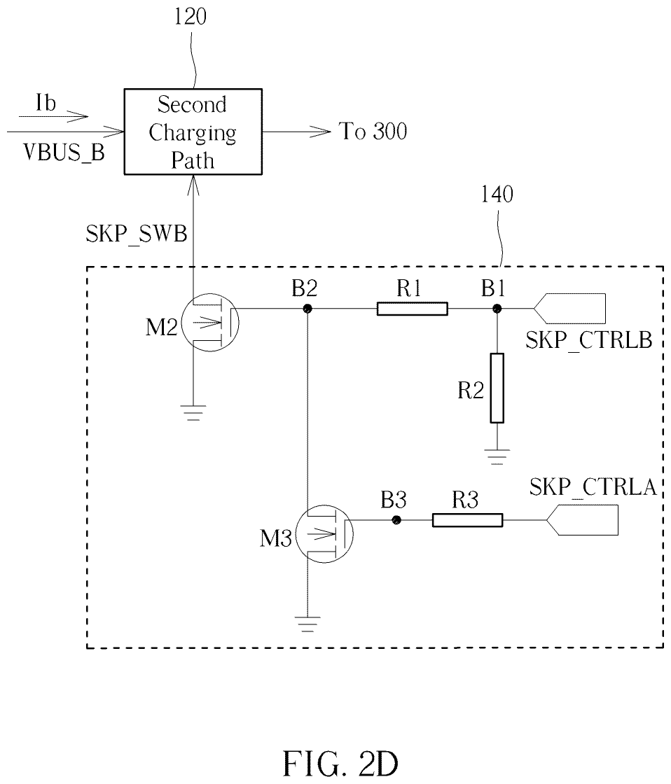

FIG. 2A illustrates a detailed schematic diagram of a multiple charging path control device according to a first embodiment of the present invention. As shown in FIG. 2A, the multiple charging path control device 100 includes a first charging path 110, a second charging path 120, a first path control circuit 130, a second path control circuit 140, and a control signal generation unit 150. Moreover, the first charging path 110 is configured to selectively provide a first charging current Ia from the first power source 10 to the electronic device 1 based on the first path switching signal SKP_SWA. The second charging path 120 is configured to selectively provide a second charging current Ib from the second power source 20 to the electronic device 1 based on the second path switching signal SKP_SWB. The first path control circuit 130 is coupled to the first charging path 110 and configured to generate the first path switching signal SKP_SWA based on a first path main control signal SKP_CTRLA. The second path control circuit 140 is coupled to the second charging path 120 and configured to generate the second path switching signal SKP_SWB based on the first path main control signal SKP_CTRLA and a second path main control signal SKP_CTRLB. The control signal generation unit 150 is coupled to the first path control circuit 130 and the second path control circuit 140, and is configured to generate the first and second path main control signals SKP_CTRLA and SKP_CTRLB, and to adjust the first and second path main control signals SKP_CTRLA and SKP_CTRLB respectively based on connection status between the first power source 10, the second power source 20, and the electronic device 1.

FIG. 2B illustrates a detailed schematic diagram of a control signal generation unit according to the first embodiment of the present invention. As shown in the figure, the control signal generation unit 150 includes power delivery negotiation controllers PDC_A and PDC_B. In one embodiment, the power delivery negotiation controllers PDC_A and PDC_B can be USB PD controllers, configurable to conduct power negotiation with the first power source 10 and the second power source 20 through signal lines CC_A and CC_B, respectively. The power delivery negotiation controllers PDC_A and PDC_B can determine power roller settings and charging voltage and current settings during the charging process through message exchange (such as PD messages). Furthermore, the power delivery negotiation controllers PDC_A and PDC_B generate the first and second path main control signals SKP_CTRLA and SKP_CTRLB, respectively, based on results of the message exchange process. In one embodiment, when the power delivery negotiation controller PDC_A determines, during the message exchange process with the first power source 10, that the electronic device 1 is assigned as the role of power sink relative to the first power source 10, the power delivery negotiation controller PDC_A would assert (assuming that the signal is preset to a low logic level) or de-assert (assuming that the signal is preset to a high logic level) the first path main control signal SKP_CTRLA. Conversely, if it is determined that the electronic device 1 is assigned as the role of the power source relative to the first power source 10 after power negotiation, the first path main control signal SKP_CTRLA will remain unchanged. Similarly, when the power delivery negotiation controller PDC_B determines, during the message exchange process with the second power source 20, that the electronic device 1 is assigned as the role of power sink relative to the second power source 20, the power delivery negotiation controller PDC_B would assert (assuming that the signal is preset to a low logic level) or de-assert (assuming that the signal is preset to a high logic level) the second path main control signal SKP_CTRLB. Conversely, if it is determined that the electronic device 1 is assigned as the role of the power source relative to the second power source 20 after power negotiation, the second path main control signal SKP_CTRLB will remain unchanged.

Please note that in the following explanation, the triggering action regarding control signals is described as “assert”, based on the assumption that the control signals are preset to a low logic level. However, those skilled in the art should understand that if these control signals are preset to a high logic level, the control signals need to be triggered by the action of “de-assert”. In such cases, the conduction type of related components (such as transistors) also needs to be adjusted accordingly, for example, replacing N-type transistors with P-type transistors in the circuits.

FIG. 2C and FIG. 2D illustrate detailed schematic diagrams of first and second path control circuits according to the first embodiment of the present invention, respectively. The first path control circuit 130 includes a transistor M1. A control terminal of transistor M1 is coupled to the first path main control signal SKP_CTRLA, and a first terminal of transistor M1 generates the first path switching signal SKP_SWA. Moreover, the second path control circuit 140 includes transistors M2 and M3. A control terminal of the transistor M2 is coupled to the second path main control signal SKP_CTRLB, and a first terminal of the transistor M2 generates the second path switching signal SKP_SWB. A control terminal of the transistor M3 is coupled to the first path main control signal SKP_CTRLA, and the first terminal of the transistor M3 is coupled to the control terminal of the transistor M2.

In this embodiment, when the first power source 10 is coupled to the electronic device 1, if the control signal generation unit 150 asserts the first path main control signal SKP_CTRLA after power negotiation, transistor M1 would conduct, causing the first path control circuit 130 to generate the first path switching signal SKP_SWA that can enable the first charging path 110 (i.e., the first path switching signal SKP_SWA does not enable the first charging path 110 when at a high logic level, and enables the first charging path 110 when at a low logic level), thus allowing the first power source 10 to provide charging current Ia to the electronic device 1. Furthermore, when the first path main control signal SKP_CTRLA is asserted, the transistor M3 conducts, pulling down the voltage at the node B2 to the ground, causing the transistor M2 not to conduct. As a result, the second path control circuit 140 will generate the second path switching signal SKP_SWB that cannot enable the second charging path 120 (i.e., the second path switching signal SKP_SWB does not enable the second charging path 120 when at a high logic level, and enables the second charging path 120 when at a low logic level). At this point, regardless of whether the second power source 20 is coupled to the electronic device 1, the second power source 20 cannot provide charging current to the electronic device 1 through the second charging path 120. On the other hand, when the second power source 20 is solely coupled to the electronic device 1, if the control signal generation unit 150 asserts the second path main control signal SKP_CTRLB after power negotiation, the transistor M2 conducts, causing the second path control circuit 150 to generate the second path switching signal SKP_SWB that can enable the second charging path 120, thus allowing the second power source 20 to provide charging current Ib to the electronic device.

In view of above, when both the first and second path main control signals SKP_CTRLA and SKP_CTRLB are asserted, the node B2 is pulled down to the ground, causing the transistor M2 not to conduct. This results in the second path control circuit 140 generating the second path switching signal SKP_SWB that cannot enable the second charging path 120, preventing the second power source 20 from providing charging current Ib to the electronic device 1. In other words, in this embodiment, when both the first and second power sources 10 and 20 are coupled to the electronic device 1, only the first power source 10 is allowed to charge the electronic device 1.

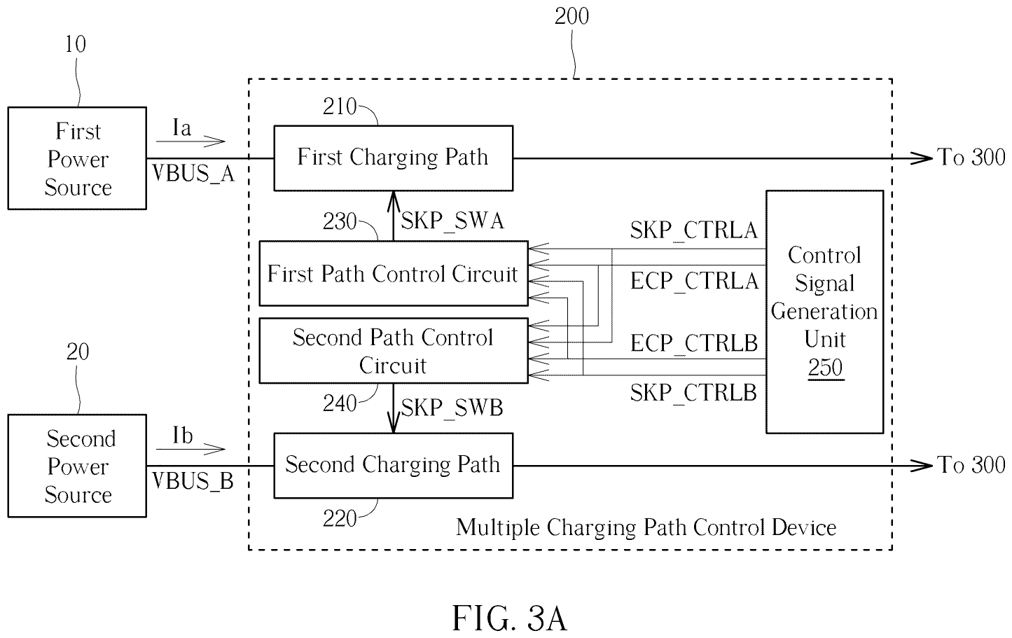

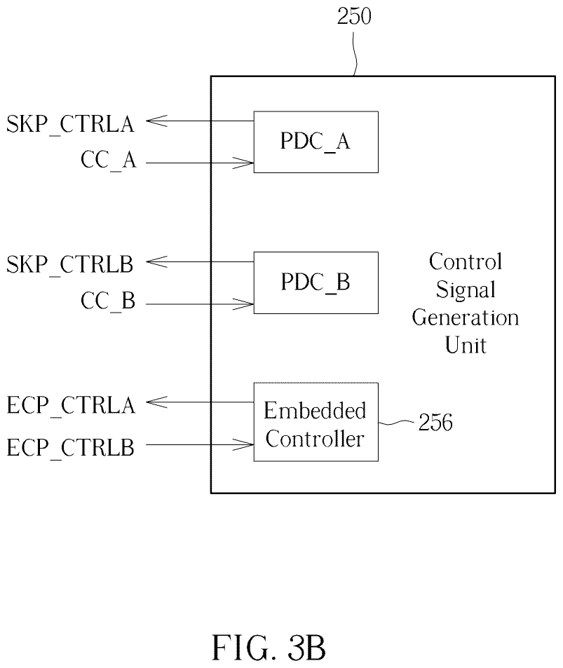

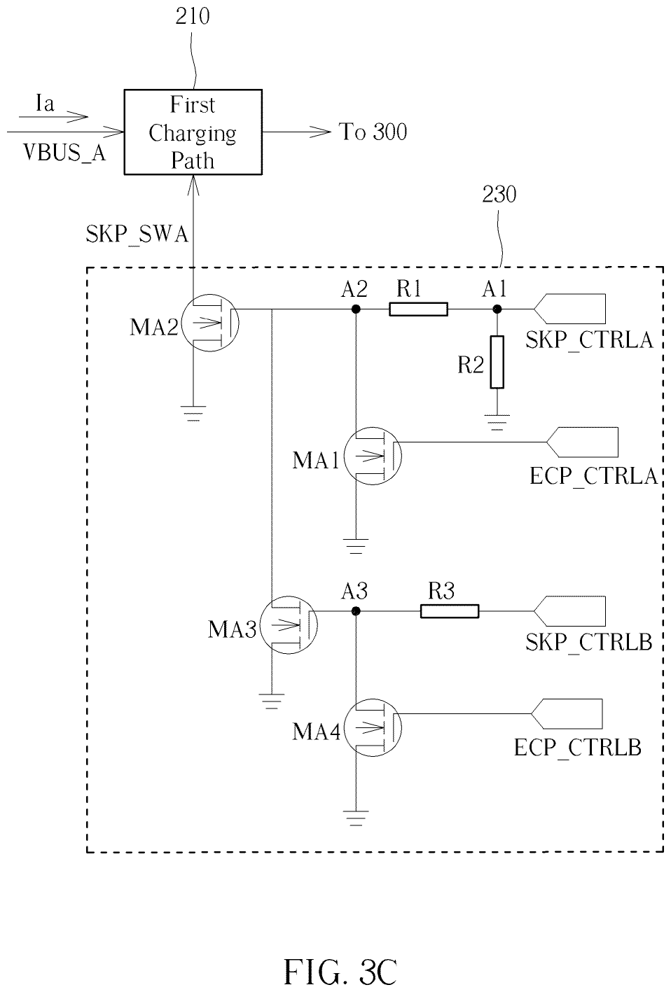

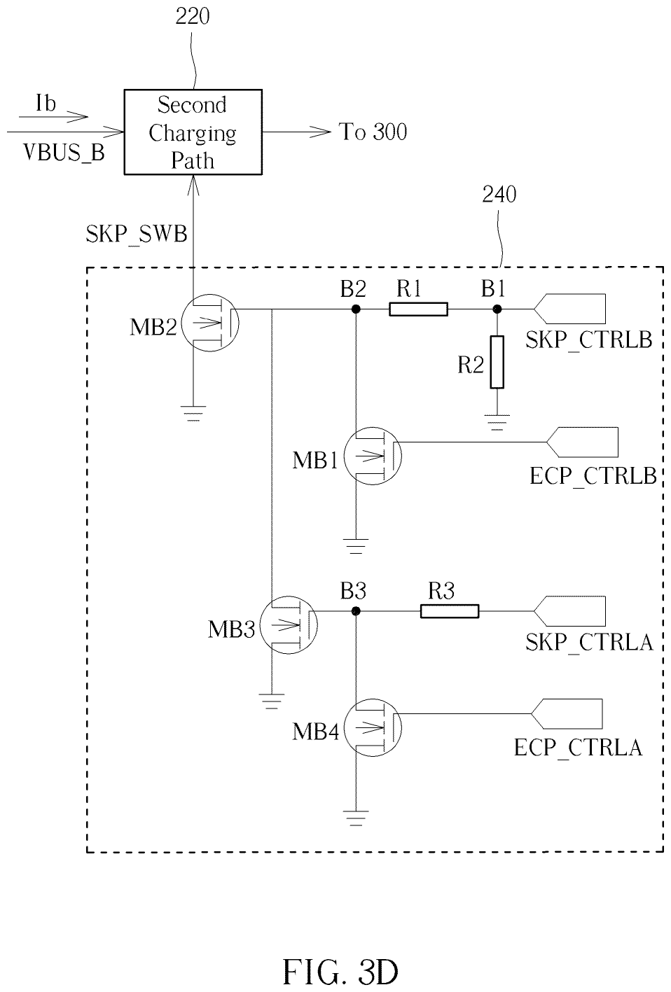

FIG. 3A illustrates a detailed schematic diagram of a multiple charging path control device according to a second embodiment of the present invention. As shown in FIG. 3A, a multiple charging path control device 200 (i.e., the second embodiment) includes a first charging path 210, a second charging path 220, a first path control circuit 230, a second path control circuit 240, and a control signal generation unit 250. Moreover, the first charging path 210 is configured to selectively provide the first charging current Ia from the first power source 10 to the electronic device 1 based on the first path switching signal SKP_SWA. The second charging path 220 is configured to selectively provide the second charging current Ib from the second power source 20 to the electronic device 1 based on the second path switching signal SKP_SWB. The first path control circuit 230 is coupled to the first charging path 210 and configured to generate the first path switching signal SKP_SWA based on the interaction of a first path main control signal SKP_CTRLA, a second path main control signal SKP_CTRLB, a first path secondary control signal ECP_CTRLA, and a second path secondary control signal ECP_CTRLB. The second path control circuit 240 is coupled to the second charging path 220 and generate the second path switching signal SKP_SWB based on the interaction of the first path main control signal SKP_CTRLA, the second path main control signal SKP_CTRLB, the first path secondary control signal ECP_CTRLA, and the second path secondary control signal ECP_CTRLB. The control signal generation unit 250 is coupled to the first path control circuit 230 and the second path control circuit 240, and is configured to generate the first and second path main control signals SKP_CTRLA and SKP_CTRLB, as well as the first and second path secondary control signals ECP_CTRLA and ECP_CTRLB. The control signal generation unit 250 is configured to adjust the first and second path main control signals SKP_CTRLA and SKP_CTRLB based on the connection status of the first power source 10 and the second power source 20 to the electronic device 1. Furthermore, the control signal generation unit 250 is further configured to adjust the first and second path secondary control signals ECP_CTRLA and ECP_CTRLB based on the connection status of the first power source 10 and the second power source 20 to the electronic device 1, individual power levels (e.g., power outputs) of the first power source 10 and the second power source 20, and/or user settings.

FIG. 3B illustrates a detailed structural diagram of a control signal generation unit according to the second embodiment of the present invention. As shown in the figure, the control signal generation unit 250 includes power delivery negotiation controllers PDC_A and PDC_B, as well as an embedded controller 256. In one embodiment, the power delivery negotiation controllers PDC_A and PDC_B can be USB PD controllers, configurable to conduct power negotiation with the first power source 10 and the second power source 20 through signal lines CC_A and CC_B, respectively. The power delivery negotiation controllers PDC_A and PDC_B can determine role settings and charging voltage and current settings during the charging process through message exchange (such as PD messages). Furthermore, the power delivery negotiation controllers PDC_A and PDC_B generate the first and second path main control signals SKP_CTRLA and SKP_CTRLB, respectively, based on results of the message exchange process. In one embodiment, when the power delivery negotiation controller PDC_A determines, during the message exchange process with the first power source 10 that the electronic device 1 is assigned as the role of power sink relative to the first power source 10, the power delivery negotiation controller PDC_A would assert (assuming that the signal is preset to a low logic level) or de-assert (assuming that the signal is preset to a high logic level) the first path main control signal SKP_CTRLA. Conversely, if it is determined that the electronic device 1 is assigned as the role of power source relative to the first power source 10 after power negotiation, the first path main control signal SKP_CTRLA will remain unchanged. Similarly, when the power delivery negotiation controller PDC_B determines, during the message exchange process with the second power source 20, that the electronic device 1 is assigned as the role of power sink relative to the second power source 20, the power delivery negotiation controller PDC_B will assert (assuming that the signal is preset to a low logic level) or de-assert (assuming that the signal is preset to a high logic level) the second path main control signal SKP_CTRLB. Conversely, if it is determined that the electronic device 1 is assigned as the role of power source relative to the second power source 20 after power negotiation, the second path main control signal SKP_CTRLB will remain unchanged. Additionally, the embedded controller 256 can generate/adjust the first and second path secondary control signals ECP_CTRLA and ECP_CTRLB, asserting or de-asserting the first and second path secondary control signals ECP_CTRLA and ECP_CTRLB based on the connection status and/or power detection results for the first power source 10 and the second power source 20, or based on user settings (such as the user specifying a particular power source for charging).

FIG. 3C and FIG. 3D illustrate detailed schematic diagrams of the first and second path control circuits according to the second embodiment of the present invention, respectively. The first path control circuit 230 includes transistors MA1-MA4. A control terminal of the transistor MA1 is coupled to the first path secondary control signal ECP_CTRLA, and a first terminal of the transistor MAL is coupled to the first path main control signal SKP_CTRLA. A control terminal of the transistor MA2 is coupled to the first path main control signal SKP_CTRLA and the first terminal of the transistor MA1, while a first terminal of the transistor MA2 generates the first path switching signal SKP_SWA. A control terminal of the transistor MA3 is coupled to the second path main control signal SKP_CTRLB, and a first terminal of the transistor MA3 is coupled to the control terminal of the transistor MA2 and the first path main control signal SKP_CTRLA. A control terminal of the transistor MA4 is coupled to the second path secondary control signal ECP_CTRLB, and a first terminal of the transistor M4 is coupled to the control terminal of transistor MA3 and the second path main control signal SKP_CTRLB.

Moreover, the second path control circuit 240 includes transistors MB1-MB4. A control terminal of the transistor MB1 is coupled to the second path secondary control signal ECP_CTRLB, and a first terminal of the transistor MB1 is coupled to the second path main control signal SKP_CTRLB. A control terminal of the transistor MB2 is coupled to the second path main control signal SKP_CTRLB and the first terminal of the transistor MB1, while a first terminal of the transistor M2 is used to generate the second path switching signal SKP_SWB. A control terminal of the transistor MB3 is coupled to the first path main control signal SKP_CTRLA, and a first terminal of the transistor MB3 is coupled to the control terminal of transistor MB2 and the second path main control signal SKP_CTRLB. A control terminal of the transistor MB4 is coupled to the first path secondary control signal ECP_CTRLA, and a first terminal of the transistor MB4 is coupled to the control terminal of the transistor MB3 and the first path main control signal SKP_CTRLA.

In this embodiment, when the first power source 10 is coupled to the electronic device 1, if the control signal generation unit 250 determines, based on power negotiation, that the electronic device 1 is assigned as the role of power sink relative to the first power source 10, the control signal generation unit 250 will assert the first path main control signal SKP_CTRLA. When the second power source 20 is coupled to the electronic device 1, if the control signal generation unit 250 determines, based on power negotiation, that the electronic device 1 is assigned as the role of power sink relative to the second power source 20, the control signal generation unit 250 will assert the second path main control signal SKP_CTRLB.

Furthermore, if the first power source 10 is solely coupled to the electronic device 1 (or if the second power source 20 is coupled to the electronic device 1, but the electronic device 1 is not assigned as the role of power sink relative to the second power source 20), the control signal generation unit 250 will de-assert the first path secondary control signal ECP_CTRLA and assert the second path secondary control signal ECP_CTRLB. This ensures that the node A2 is not pulled down to the ground, thereby allowing the transistor MA2 to conduct. As a result, the first path control circuit 230 generates the first path switching signal SKP_SWA that can enable the first charging path 210 (i.e., the first path switching signal SKP_SWA does not enable the first charging path 210 when at a high logic level, and enables the first charging path 210 when at a low logic level), thus allowing the first power source 10 to provide charging current Ia to the electronic device 1. Additionally, the assertion of the second path secondary control signal ECP_CTRLB will cause the node B2 to be pulled down to the ground, resulting in the transistor MB2 not conducting. This causes the second path control circuit 240 to generate the second path switching signal SKP_SWB that cannot enable the second charging path 220 (i.e., the second path switching signal SKP_SWB does not enable the second charging path 220 when at a high logic level, and enables the second charging path 220 when at a low logic level), thus preventing the second power source 20 from providing charging current Ib to the electronic device 1.

When the second power source 20 is solely coupled to the electronic device 1 (or if the first power source 10 is coupled to the electronic device 1, but the electronic device 1 is not assigned as the role of power sink relative to the first power source 10), the control signal generation unit 250 will assert the first path secondary control signal ECP_CTRLA and de-assert the second path secondary control signal ECP_CTRLB. This ensures that the node B2 is not pulled down to the ground, allowing the transistor MB2 to conduct. As a result, the second path control circuit 240 generates the second path switching signal SKP_SWB that can enable the second charging path 220, thus allowing the second power source 20 to provide charging current Ib to the electronic device 1. Furthermore, since the node A2 is pulled down to the ground at this time, the transistor MA2 does not conduct, causing the first path control circuit 210 to generate the first path switching signal SKP_SWA that cannot enable the first charging path 210, thus preventing the first power source 10 from providing charging current Ia to the electronic device 1.

Moreover, when the first power source 10 is coupled to the electronic device 1 before the second power source 20 (or if the user specifies the use of the first power source 10 for power supply), the control signal generation unit 250 maintains the de-assertion of the first path secondary control signal ECP_CTRLA and the assertion of the second path secondary control signal ECP_CTRLB. In other words, the control signal generation unit 250 maintains the signal states of the first path secondary control signal ECP_CTRLA and the second path secondary control signal ECP_CTRLB that were established when the first power source 10 was solely coupled to the electronic device 1. This ensures that the node A2 is not pulled down to the ground, allowing the transistor MA2 to conduct, causing the first path control circuit 230 to generate the first path switching signal SKP_SWA that can enable the first charging path 210, thus allowing the first power source 10 to provide charging current Ia to the electronic device 1. Additionally, due to the assertion of the second path secondary control signal ECP_CTRLB, the node B2 is pulled down to the ground, causing the transistor MB2 not to conduct. This results in the second path control circuit 240 generating the second path switching signal SKP_SWB that cannot enable the second charging path 220, thus preventing the second power source 20 from providing charging current Ib to the electronic device 1.

Furthermore, when the second power source 20 is coupled to the electronic device 1 before the first power source 10 (or if the user specifies the use of the second power source 20 for power supply), the control signal generation unit 250 maintains the assertion of the first path secondary control signal ECP_CTRLA and the de-assertion of the second path secondary control signal ECP_CTRLB. In other words, the control signal generation unit 250 maintains the signal states of the first path secondary control signal ECP_CTRLA and the second path secondary control signal ECP_CTRLB that were established when the second power source 20 was solely coupled to the electronic device 1. This ensures that the node B2 is not pulled down to the ground, allowing the transistor MB2 to conduct, causing the second path control circuit 240 to generate the second path switching signal SKP_SWB that can enable the second charging path 220, thus allowing the second power source 20 to provide charging current Ib to the electronic device 1. Moreover, since the node A2 is pulled down to the ground at this time, the transistor MA2 does not conduct, causing the first path control circuit 210 to generate the first path switching signal SKP_SWA that cannot enable the first charging path 210, thus preventing the first power source 10 from providing charging current Ia to the electronic device 1.

On the other hand, when the power level of the first power source 10 is greater than that of the second power source 20, the control signal generation unit 250 de-asserts the first path secondary control signal ECP_CTRLA and asserts the second path secondary control signal ECP_CTRLB. This causes the first path control circuit 230 to generate the first path switching signal SKP_SWA that can enable the first charging path 210, and causes the second path control circuit 240 to generate the second path switching signal SKP_SWB that cannot enable the second charging path 220, thus allowing only the first power source 10 to provide charging current Ia to the electronic device 1. Conversely, when the power level of the second power source 20 is greater than that of the first power source 10, the control signal generation unit 250 asserts the first path secondary control signal ECP_CTRLA and de-asserts the second path secondary control signal ECP_CTRLB. This causes the second path control circuit 240 to generate the second path switching signal SKP_SWB that can enable the second charging path 220, and causes the first path control circuit 230 to generate the first path switching signal SKP_SWA that cannot enable the first charging path 210, thus allowing only the second power source 20 to provide charging current Ib to the electronic device 1.

In summary, the present invention achieves the management of multiple charging paths through transistor-based path control circuits 130, 140, 230, and 240. As the path control circuits in the present invention are implemented using hardware circuits, which offer excellent response speed without latency. Moreover, in different embodiments of the present invention, the path control circuits can support simple switching logic (such as in the first embodiment, which designates a specific connection interface as a preferred option), or switching logic based on multiple decision criteria (such as in the second embodiment, which can consider power source connection order, power level, and/or user settings), thereby enhancing application flexibility. Consequently, the present invention provides a multiple charging path control device that combines rapid response with application flexibility.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multiple charging path control device for use in an electronic device with multiple connection interfaces, comprising:
a first charging path, configured to selectively provide a first charging current from a first power source to the electronic device according to a first path switching signal;
a second charging path, configured to selectively provide a second charging current from a second power source to the electronic device according to a second path switching signal a first path control circuit, coupled to the first charging path, configured to generate the first path switching signal based on at least a first path main control signal;
a second path control circuit, coupled to the second charging path, configured to generate the second path switching signal based on at least the first path main control signal and a second path main control signal; and
a control signal generation unit, coupled to the first path control circuit and the second path control circuit, configured to generate the first and second path main control signals and adjusting the first and second path main control signals according to connection status of the first and second power sources and the electronic device;
wherein when the first power source is coupled to the electronic device, the control signal generation unit is configured to assert the first path main control signal, causing the first path control circuit to generate the first path switching signal that can enable the first charging path, and simultaneously causing the second path control circuit to generate the second path switching signal that cannot enable the second charging path.

2. The multiple charging path control device of claim 1, wherein when the second power source is coupled to the electronic device, the control signal generation unit is configured to assert the second path main control signal, causing the second path control circuit to generate the second path switching signal that can enable the second charging path; and when both the first and second power sources are coupled to the electronic device, resulting in both the first and second path main control signals being asserted, the second path control circuit generates the second path switching signal that cannot enable the second charging path.

3. The multiple charging path control device of claim 2, wherein the first path control circuit comprises a first transistor; a control terminal of the first transistor is coupled to the first path main control signal, and a first terminal of the first transistor generates the first path switching signal.

4. The multiple charging path control device of claim 2, wherein the second path control circuit comprises a second transistor and a third transistor; a control terminal of the second transistor is coupled to the second path main control signal, and a first terminal of the second transistor generates the second path switching signal; a control terminal of the third transistor is coupled to the first path main control signal, and a first terminal of the third transistor is coupled to the control terminal of the second transistor.

5. The multiple charging path control device of claim 1, wherein the control signal generation unit is further configured to generate the first path main control signal, the second path main control signal, a first path secondary control signal, and a second path secondary control signal; the first path control circuit is configured to generate the first path switching signal based on the first path main control signal, the second path main control signal, the first path secondary control signal, and the second path secondary control signal; and the second path control circuit is configured to generate the second path switching signal based on the first path main control signal, the second path main control signal, the first path secondary control signal, and the second path secondary control signal.

6. The multiple charging path control device of claim 5, wherein the control signal generation unit is configured adjust the first and second path secondary control signals respectively, based on connection status of the first and second power sources to the electronic device, individual power levels of the first and second power sources, and/or user settings.

7. The multiple charging path control device of claim 6, wherein when the first power source is solely coupled to the electronic device, the control signal generation unit is configured to de-assert the first path secondary control signal and assert the second path secondary control signal, causing the first path control circuit to generate the first path switching signal that can enable the first charging path, and causing the second path control circuit to generate the second path switching signal that cannot enable the second charging path; and when the second power source is solely coupled to the electronic device, the control signal generation unit is configured to assert the first path secondary control signal and de-assert the second path secondary control signal, causing the second path control circuit to generate the second path switching signal that can enable the second charging path, and causing the first path control circuit to generate the first path switching signal that cannot enable the first charging path.

8. The multiple charging path control device of claim 7, wherein when the first power source is coupled to the electronic device prior to the second power source, the control signal generation unit is configured to maintain de-assertion of the first path secondary control signal and maintain assertion of the second path secondary control signal; and when the second power source is coupled to the electronic device prior to the first power source, the control signal generation unit is configured to maintain assertion of the first path secondary control signal and maintain de-assertion of the second path secondary control signal.

9. The multiple charging path control device of claim 7, wherein when the power level of the first power source is greater than that of the second power source, or when the user settings specify the use of the first power source, the control signal generation unit is configured to de-assert the first path secondary control signal and assert the second path secondary control signal, causing the first path control circuit to generate the first path switching signal that can enable the first charging path, and causing the second path control circuit to generate the second path switching signal that cannot enable the second charging path; when the power level of the second power source is greater than that of the first power source, or when the user settings specify the use of the second power source, the control signal generation unit is configured to assert the first path secondary control signal and de-assert the second path secondary control signal, causing the second path control circuit to generate the second path switching signal that can enable the second charging path, and causing the first path control circuit to generate the first path switching signal that cannot enable the first charging path.

10. The multiple charging path control device of claim 5, wherein the first path control circuit comprises a first transistor, a second transistor, a third transistor, and a fourth transistor; a control terminal of the first transistor is coupled to the first path secondary control signal, and a first terminal of the first transistor is coupled to the first path main control signal; a control terminal of the second transistor is coupled to the first path main control signal and the first terminal of the first transistor, and a first terminal of the second transistor generates the first path switching signal; a control terminal of the third transistor is coupled to the second path main control signal, and a first terminal of the third transistor is coupled to the control terminal of the second transistor and the first path main control signal; a control terminal of the fourth transistor is coupled to the second path secondary control signal, and a first terminal of the fourth transistor is coupled to the control terminal of the third transistor and the second path main control signal.

11. The multiple charging path control device of claim 9, wherein the second path control circuit comprises a fifth transistor, a sixth transistor, a seventh transistor, and an eighth transistor; a control terminal of the fifth transistor is coupled to the second path secondary control signal, and a first terminal of the fifth transistor is coupled to the second path main control signal; a control terminal of the sixth transistor is coupled to the second path main control signal and the first terminal of the fifth transistor, and a first terminal of the sixth transistor generates the second path switching signal; a control terminal of the seventh transistor is coupled to the first path main control signal, and a first terminal of the seventh transistor is coupled to the control terminal of the sixth transistor and the second path main control signal; a control terminal of the eighth transistor is coupled to the first path secondary control signal, and a first terminal of the eighth transistor is coupled to the control terminal of the seventh transistor and the first path main control signal.

12. An electronic device comprising the multiple charging path control device of claim 1.
